(19) United States
(12) Patent Application Publication
(10) Pub. No.: US 2017/0178169 A1
(43) Pub. Date: Jun. 22, 2017

(54) BID DISTRIBUTION PREDICTION AND AUCTION EFFICIENCY

(71) Applicant: LinkedIn Corporation, Mountain View, CA (US)

(72) Inventors: Kun Liu, San Jose, CA (US); Tingting Cui, Mountain View, CA (US); Changming Ma, Sunnyvale, CA (US)

(21) Appl. No.: 14/977,498

(22) Filed: Dec. 21, 2015

(51) Int. Cl. G06Q 30/02

(52) U.S. Cl. CPC G06Q 30/0206; G06Q 30/0275; G06Q 30/0277

(57) ABSTRACT

A method includes receiving historical bids for displaying content to individuals. The historical bids targeted a segment of the individuals based on one or more targeting attributes of the individuals. The method further includes calculating, for each individual, a predicted bid distribution based on the historical bids and one or more targeting attributes of each individual, calculating, using the predicted bid distribution for each individual, a reserve price for displaying content to each individual, and setting a floor price of an auction for displaying content to an individual to the reserve price associated with the individual.

### TECHNICAL FIELD

The present disclosure relates generally to online auctions for displaying content, such as advertisements, to individuals.

### BACKGROUND

Presenting content, such as advertisements, to individuals on the Internet is critical to the existence of many organizations. Advertisers may run advertising campaigns on a website, such as a search engine, social media website, and/or e-commerce website to increase exposure to goods and/or services shown in the advertising campaign, or for any other purpose. The advertisers purchase space to show their advertising campaigns through an auction. In the auction, one or more advertisers are bidding to show their advertisement to individuals using the website where the advertisement will be shown. If an advertiser does not bid enough, then the advertiser may not receive any slots to show the advertisements, either because other advertisers outbid them, or because they did not bid more than a floor amount for targeting a group of individuals.

The auction process still uses many outdated methods. Improvements to auctions would be welcomed by advertisers and service providers alike.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 shows a block diagram of a system in accordance with an embodiment of the invention.

FIG. 2 shows a flowchart of a method in accordance with an embodiment of the invention.

FIG. 3 shows an example in accordance with an embodiment of the invention.

FIG. 4 shows a block diagram of a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### GENERAL OVERVIEW

Techniques are provided for bid distribution prediction and for setting reserve and/or floor prices to an amount that maximizes revenue subject to a limited loss of auction efficiency.

In one embodiment, bids are received in auctions for displaying content, such as advertisements, to users of an online website, such as a social network. The bids target groups or segments of users based on targeting attributes, such as job title, industry, degrees attained, seniority, etc. These bids may subsequently be used as input to a regression model to predict a bid distribution for individual users, rather than a segment of users. Once a bid distribution has been predicted for an individual user, a reserve price may be determined for that user. The reserve price may be used in subsequent auctions as part of an aggregate to determine a campaign level floor price, or enforced on an individual basis.

In one embodiment, reserve prices for campaigns and/or individual users are determined for maximizing revenue subject to a limited loss of auction efficiency, rather than simply maximizing revenue. Auction efficiency, or social welfare, is a measure of the joint benefit of the content provider (i.e., the person or entity paying for the right to display content) and the service provider (i.e., the person or entity selling the item). Auction efficiency may be determined using a revenue maximizing equation and a target auction efficiency as a boundary or constraint. Thus, determined reserve price will not be the revenue maximizing price, in contrast to current methods.

### Example System Implementation

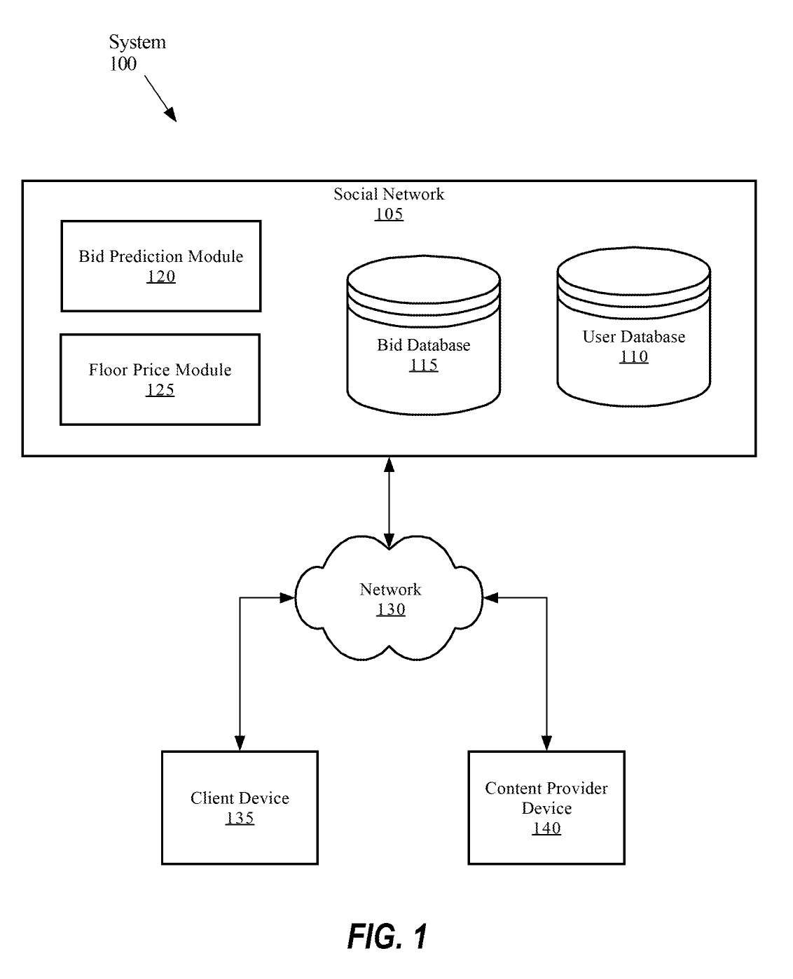

FIG. 1 illustrates an example system 100 in which the techniques described may be practiced, according to some embodiments. System 100 is a computer-based system. The various components of system 100 are implemented at least partially by hardware at one or more computing devices, such as one or more hardware processors executing instructions stored in one or more memories for performing various functions described herein. System 100 illustrates only one of many possible arrangements of components configured to perform the functionality described herein. Other arrangements may include fewer or different components, and the division of work between the components may vary depending on the arrangement.

System 100 includes social network 105, user database 110, bid database 115, bid prediction module 120, floor price module 125, network 130, client device 135, and content provider device 140. Social network 105 is a service for connecting users to other users. The connections may take many different forms. For example, connections may be unidirectional or bidirectional, and approval by one or both users may be required. Alternatively, approval may not be required. In general, social network 105 allows users to interact with other users of the social network by sending messages, posting pictures, sharing links, networking, and performing a variety of other actions. Social network 105 executes on one or more computing devices such as servers, computers, processors, database servers, and/or computing devices configured to communicate with one or more client devices 135 via network 130. The computing devices on which social network 105 executes may be located at one or more geographically distributed locations.

In one embodiment, social network 105 shows content, such as advertisements, to users on the behalf of one or more content providers. This content may be paid for by the content provider, such as an advertiser. In other words, social network 105 may receive payments to show the content to the users of social network 105. To facilitate this, social network 105 runs auctions for the available slots for showing content to the users. The auctions may be of any suitable type or format. Specifically, the auctions may be second price auctions, where the high bidder wins the item(s), but pays the price of the second highest bid. If multiple items are being sold, there may be multiple winners, each paying the price of the next highest bid, after themselves. For example, if a first bidder bids five dollars for an item, and a second bidder bids three dollars for the item, the first bidder will win the item and pay three dollars for the item. Floor prices may be used in the second price auction to ensure that goods are not sold too cheaply, and to keep the value of the good being sold at an acceptable level. For example, without a floor price, a single bidder for an item bids ten dollars, but would pay zero dollars, because there is no next highest bid. If this example were to now have a floor price of seven dollars, the single bidder would pay seven dollars for the item, rather than zero.

In one embodiment, social network 105 includes a user database 110. User database 110 is a database containing a variety of information about the users of social network 105. For example, user database 110 may include, but is not limited to: connections or connection graphs for each user and/or for various groups of users, user profiles, messages sent and/or received by users, pictures uploaded by users, demographic information, account activity, and/or any other data relating to users of the social network 105. In one embodiment, the user profiles stored by user database 110 include user supplied identifying information including, but not limited to: a profile picture, a first name, a last name, a middle name, a work place(s), a degree(s) earned, a college or university attended, a title, an industry, a location, one or more groups associated with the user (i.e., a fraternity, a church, a volunteer organization, etc.), skills, and/or other data. Although shown as a single database, user database 110 may be broken into multiple different databases in any number of geographic locations, with each database storing different types of information, or any other suitable configuration. In one embodiment, any of the information stored in user database 110 may be used as targeting attributes for showing content to the users. In other words, the information in user database 110 may be used by social network 105 and/or advertisers to target advertisements to a specific audience.

In one embodiment, bid database 115 stores historical bids received by social network 105 from content providers, for displaying content to users. The historical bids may have been received at any time, and may have targeted any segment or segments of users based on their targeting attributes. For instance, one bid may have targeted male users between the ages of 20-35, while another bid targeted users with a college degree and in the information technology industry. Bid database 115 may store any number of bids, received over any amount of time.

### Maximizing Revenue from Displaying Content

In one embodiment, social network 105 may execute any number of modules and/or applications, such as an auction revenue maximizing module (not shown). The auction revenue maximizing module determines reserve prices for auctions in such a way as to maximize the amount of revenue that social network 105 may receive from the auctions. Maximizing revenue from auctions is an area of study in the field of auction theory. With a few assumptions, the complex problem of maximizing revenue can be reduced to a solvable equation. Assumptions include that: the content providers that bid on auctions are risk neutral, the bids do not change with the reserve price, and the bid distribution is independent and identically distributed (i.i.d) from all content providers. The resulting equation for maximizing revenue is: r*=(1−F(r*))/f(r*), wherein r* is revenue maximizing reserve price, F is the cumulative distribution function (CDF) of the bid distribution, and f is the probability density function (PDF) of the bid distribution. A CDF describes the probability that a real-valued random variable X with a given probability distribution will be found to have a value less than or equal to x. A PDF describes the relative likelihood for a random variable to take on a given value. By making the further assumption that the bid distribution is log normal(μ, σ²), the equation for determining optimal reserve price becomes r*=G(μ, σ)=exp(μ+C(σ)), where μ is the mean of a normal distribution, and C(σ) is a function of the mean residual standard error.

However, the functions discussed above require there to be a sufficient amount of bids in order to produce accurate results. Further, auctions and bids for displaying content to users have historically been applied to large groups of users simultaneously. In other words, the bids were for the entire segment of users that the content provider was targeting—not individual users within a segment of users. Optimizing revenue for individual users, rather than large segments of users, when there are potentially millions of users—or more—is a challenging problem. In particular, there may be insufficient or no bids directed specifically towards any individual user, rendering the above equations ineffective. Social network 105 does, however, have access to the historical bid data targeting segments of users that may share one or more attributes with a given user in bid database 115. This historical data may be leveraged to predict the bid distribution for individual users.

### Predicting Bid Distribution for an Individual User

As shown in FIG. 1, social network 105 executes a bid prediction module 120. Bid prediction module 120 includes functionality to predict bids for an individual user when there are few or no bids targeting the individual user. Specifically, bid prediction module 120 predicts a bid distribution for an individual user based on the targeting attributes of the individual user and historical bids targeting segments of users with one or more of the same targeting attributes as the individual user.

In one embodiment, bid prediction module 120 utilizes a linear regression to predict the bid distribution of an individual user. Specifically, in the linear regression, the response variable is the log bid (denoted by log B), and the explanatory variable(s) is the user's targeting attributes (denoted by X). The linear regression may be of the form: Y=log B=Xβ+ε,ε˜N(0, σ²l), where β is a coefficient, ε is an arbitrarily small positive quantity—meaning that the residual noise follows an i.i.d. normal distribution. Bid prediction module 120 processes the bid predictions for each user as an offline process, which may be updated for the users on a predetermined basis, such as once a week, once a month, etc. In one embodiment, bid prediction module 120 uses many different computing devices to predict the bid distributions. Specifically, the bid prediction module 120 may execute on a Hadoop cluster.

In one embodiment, after bid prediction module 120 has solved for coefficient β*, bid prediction module 120 may estimate μ and σ for a given user, i, as: μ=xᵢβ*, σ²=Σᵢ(yᵢ-xᵢβ*)²/n, where β* is the least square estimate of the coefficient, xᵢ is the vector of the targeting attributes for the user i, and yᵢ is the log bid for the user i. In the preceding equation, every user shares the same σ, which is equal to the mean residual standard error. In particular, bid prediction module 120 is useful for switching to a user-specific reserve pricing from a campaign or segment of user reserve pricing. Additionally, bid prediction module 120 is also particularly useful when applied to new users who may have not been targeted by any advertisements yet, and thus have no bids related to them. By predicting the bid distributions in these two scenarios, effective and accurate reserve prices may be determined for these users.

### Limiting Loss of Auction Efficiency

In auctions for displaying content to users, the expectation is for service providers to optimize for revenue. This is because service providers want to make as much money as they can when selling their items. There are various ways to increase or regulate revenue from auctions. One tool for auctioneers is setting a floor price, or reserve price. There may be many different types of floors. As discussed above, one type of floor is specific to each individual user, and may be used or enforced at the time when the content is about to be displayed to the associated user, or at any other suitable time. Another type of floor is a campaign level floor. A campaign level floor applies to every bid a content provider makes for a given campaign. For example, a content provider may decide to allocate $50,000 to displaying content to a selected segment of users. The campaign level floor would regulate the minimum acceptable bid for the entire duration of the campaign.

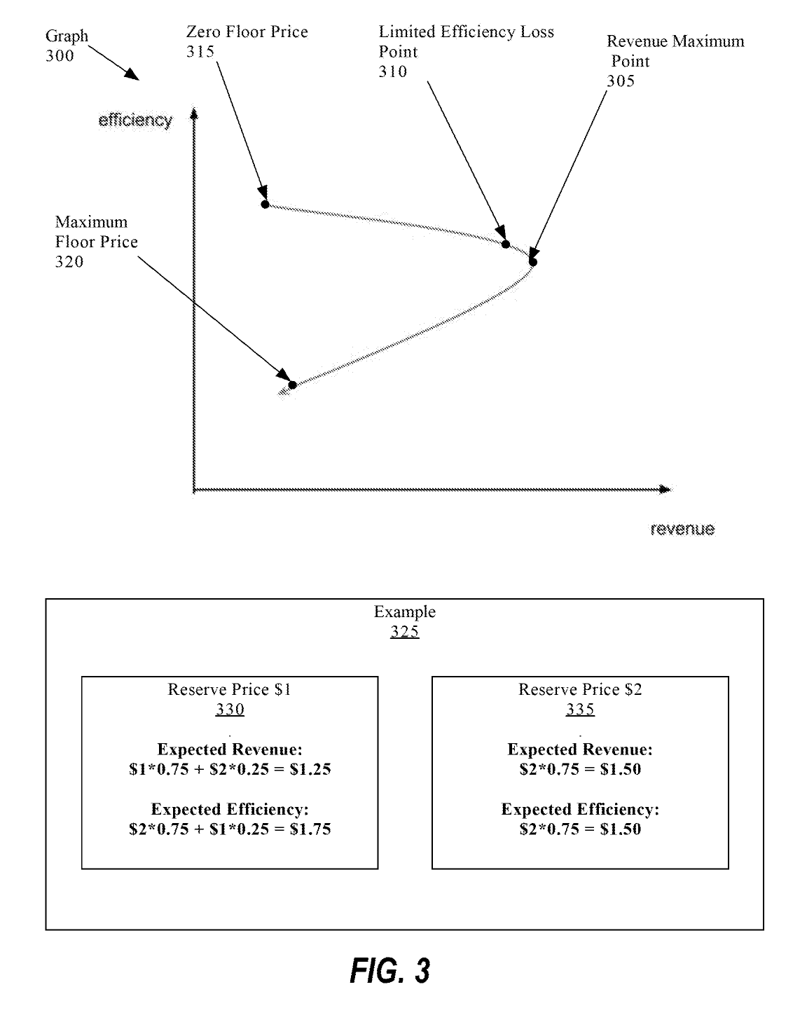

In one embodiment, floor price module 125 includes functionality to optimize the floor price for revenue subject to a limit on auction efficiency. Auction efficiency, or social welfare, is a measure of the joint benefit to both the entity running the auction and the content providers that are bidding on the auction. An example graph of auction efficiency and auction revenue is shown in FIG. 3. As graph 300 shows, the tradeoff of efficiency and revenue is shown as the floor price increases in the direction of the arrow. At zero floor price 315, the amount of successful auctions is highest, as no bids are rejected due to not exceeding a floor price. Conversely, at maximum floor price 320, the amount of successful auctions is at the lowest, because few, if any, bids exceed the floor price. Traditionally, auctioneers tried to set their floor prices at revenue maximum point 305, because this resulted in the auctioneers receiving the maximum amount of revenue that they could. However, for a slight reduction in revenue, a large gain in auction efficiency may be had at limited efficiency loss point 310.

FIG. 3 also shows example 325, which details data representing a simplified second price auction for a single item, with two bidders. The bid distribution for this auction is a discrete distribution with a $1 bid at 0.50 probability, and a $2 bid with 0.50 probability. Additionally, the reserve price may only be $1 or $2 for the purposes of this example. Under these conditions the expected revenue and efficiency are shown. At reserve price $1 330, the expected revenue is $1.25, calculated from a 75% chance of a $1 bid paid for the auction, and a 25% chance of a $2 bid paid for the auction. This is because there are only 4 potential bid combinations: $1 and $1 (resulting in a $1 price paid for the auction), $2 and $1 (resulting in a $1 price paid for the auction), $1 and $2 (resulting in a $1 price paid for the auction), and $2 and $2 (resulting in a $2 price paid for the auction). Similarly, the expected efficiency is $1.75, calculated from a 75% chance of $2 efficiency, and a 25% chance of $1 efficiency. The efficiency is $2 in all cases except when both bids are $1. This is because the efficiency is a measure of the joint benefit to both the auctioneer and the content provider. When a content provider bids $2, but pays $1, the benefit is $1 to the content provider and $1 to the auctioneer (because the auctioneer makes $1 in profit, while the content provider gets a good he/she valued at $2 for $1, resulting in $1 “gain” for the content provider). Similarly, if both bids are $2, then the auctioneer receives all $2 of the benefit. In the instance where both bids are $1, the auctioneer receives all $1 of the benefit. Thus, a reserve price of $1 results in an efficiency of $1.75 and revenue of $1.25.

Continuing the example in FIG. 3, when the reserve price is $2, the expected revenue is $1.5, calculated as a 75% chance of $2 revenue, and a 25% chance of the item going unsold, due to the $1 bid not meeting the $2 reserve price. Likewise, the expected efficiency is also $1.5, calculated as a 75% chance of $2 efficiency, and a 25% chance of the item going unsold. Thus, when comparing the $1 or $2 reserve prices, the $1 reserve price results in a $0.25 higher efficiency than the $2 reserve price, and is the price with limited efficiency loss in this example. On the other hand, the $2 reserve price results in a $0.25 higher revenue than the $1 reserve price, and is the optimized price for revenue in this example.

Returning to FIG. 1, floor price module 125 includes functionality to set the floor price to a level that optimizes for revenue subject to a limited loss of auction efficiency. In one embodiment, floor price module 125 places a constraint on a revenue maximizing equation. The constraint may be a maximum, or target, amount of efficiency loss. For example, a target amount of efficiency might be 97%, meaning that 3% of available items go unsold. Alternatively, a target amount of efficiency might be 94%, 90%, or any other amount. Specifically, floor price module 125 will result in the floor price decreasing in comparison to a purely revenue maximizing floor price, and therefore the target efficiency amount should not be less than the auction efficiency at the revenue maximizing floor price.

In one embodiment, network 130 comprises a communications network, such as a local area network (LAN), a wireless LAN (WLAN), a wide area network (WAN), a wireless WAN (WWAN), a metropolitan area network (MAN), an ad hoc network, an intranet, an extranet, a virtual private network (VPN), a portion of the Internet, the Internet, a portion of a public switched telephone network (PSTN), a cellular network, or a combination of two or more such networks. When network 130 comprises a public network, security features (e.g., VPN/SSL secure transport) may be included to ensure authorized access within system 100.

Client device 135 is a computing device, including but not limited to: work stations, personal computers, general purpose computers, laptops, Internet appliances, hand-held devices, wireless devices, wired devices, portable or mobile devices, wearable computers, cellular or mobile phones, portable digital assistants (PDAs), smart phones, tablets, multi-processor systems, microprocessor-based or programmable consumer electronics, game consoles, set-top boxes, network PCs, mini-computers, and the like. Client device 135 includes applications, software, and/or other executable instructions to facilitate various aspects of the invention described herein. Specifically, client device 135 is able to display content to users of social network 105, such as advertisements. Client device 135 may also include additional applications or other interface capabilities to communicate with social network 105. In one embodiment, there may be any number of client devices, such as one per user of social network 105.

Content provider device 140 is a computing device, including but not limited to: work stations, personal computers, general purpose computers, laptops, Internet appliances, hand-held devices, wireless devices, wired devices, portable or mobile devices, wearable computers, cellular or mobile phones, portable digital assistants (PDAs), smart phones, tablets, multi-processor systems, microprocessor-based or programmable consumer electronics, game consoles, set-top boxes, network PCs, mini-computers, and the like. Content provider device 140 includes applications, software, and/or other executable instructions to facilitate various aspects of the invention described herein. Specifically, content provider device 140 is able to bid on auctions to display content display content to users of social network 105, and provide the content to social network 105 for display. Content provider device 140 may also include additional applications or other interface capabilities to communicate with social network 105. In one embodiment, there may be any number of content provider devices 140, such as one (or more) per advertiser on social network 105.

### Example Functional Implimentation

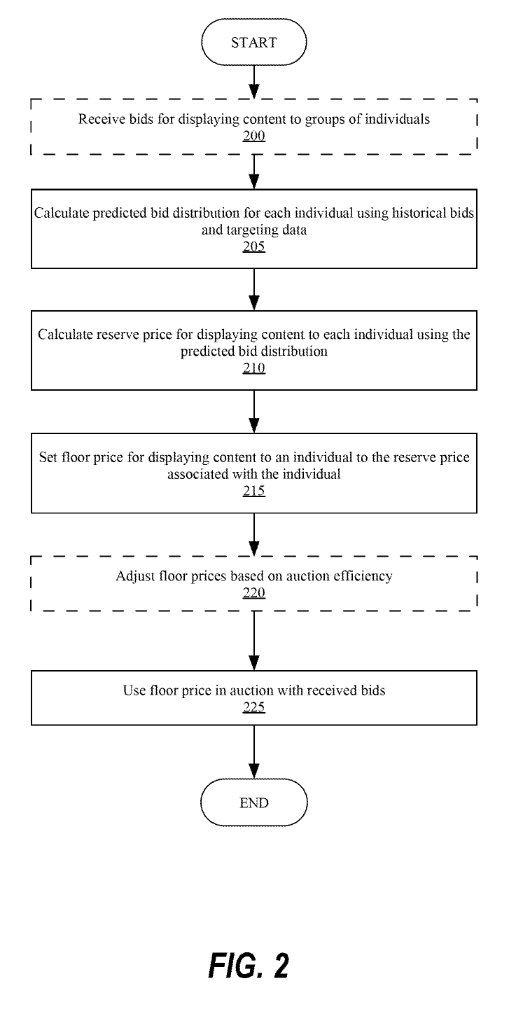

FIG. 2 shows an example flowchart of a method for connection prediction as identity verification. Although the steps in FIG. 2 are shown in an order, the steps of FIG. 2 may be performed in any order, and are not limited to the order shown in FIG. 2. Additionally, some steps may be optional, may be performed multiple times, and/or may be performed by different components.

In step 200, bids are received for displaying content to groups of individuals. The bids may be received from any number of different content providers, and may be received in any suitable format. The bids may be directed to specific individuals, or to groups of users of a website, or other online service. In one embodiment, the bids are targeted to users or groups of users based on targeting attributes, such as industry, degrees attained, seniority, job title, groups, interests, connections, etc. As indicated by the dotted lines, the bids are historical, and may have been received at any time, and may continue to be received during the subsequent steps of the method. In one embodiment, multiple bids may be received at approximately the same time for the same individual or groups of users, and/or multiple bids may be received for the same individual or group of users at separate times. For example, a first auction on a first day receives multiple bids for user A, while a second auction on a subsequent day receives only a single bid for user A.

In step 205, predicted bid distributions are calculated for each individual using historical bids and targeting data. Specifically, a linear regression is used to calculate the predicted bid distribution. The linear regression uses the log bid as the response variable, and the explanatory variable(s) are the targeting attributes of the member for whom the bid distribution is being calculated. In one embodiment, the formula is: Y=log B=Xβ+ε,ε˜N(0, σ²l). After the coefficient β is solved for, μ and σ are estimated for user i, as: μ=xᵢβ*, σ²=Σᵢ,(yᵢ−xᵢβ*)²/n. Through these calculations a bid distribution may be determined for individual users when they lack sufficient historical bids to accurately determine a reserve price.

In step 210, a reserve price for displaying content to each individual is calculated using the predicted bid distribution. The reserve price may be predicted using any suitable formula(s). In one embodiment, the formula used may take the form of: r*=G(μ, σ)=exp(μ+C(σ)). The reserve price may be calculated in an offline process, and may be updated over time as new bids are received. For example, the reserve prices may be calculated using a Hadoop cluster.

In step 215, the floor price for displaying content to an individual is set to the reserve price associated with the individual. The floor price may be set in real time at a campaign or group level or on an individual basis. For example, a campaign level floor may be generated for a group of individuals by aggregating the individual reserve prices and averaging them, to arrive at a campaign level floor.

In step 220, the floor price is adjusted based on auction efficiency. As indicated by the dotted lines, step 220 is optional. Auction efficiency, or social welfare, is a measure of the joint benefit to both the content provider and to the auctioneer. The auction efficiency is a boundary or constraint on a revenue maximizing equation. In one embodiment, a target amount of loss in auction efficiency is 3% of slots for displaying content, or advertisements, going unsold. Alternatively, any other amount of slots for displaying content may go unsold.

In step 225, the floor price is used in an auction with received bids. The floor price may be enforced on a campaign or group level, on an individual level, or both. The floor price may result in some items being unsold.

### Hardware Overview

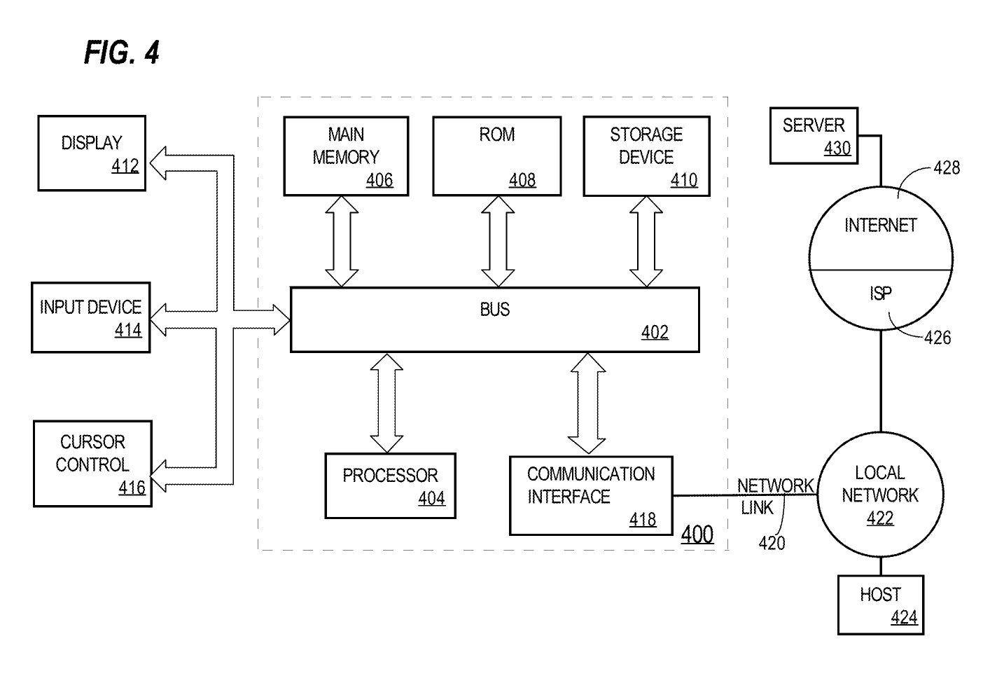

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques. For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving a plurality of historical bids for displaying first content to a plurality of individuals, wherein each of the plurality of historical bids targeted a segment of the plurality of individuals based on one or more targeting attributes of the plurality of individuals;
calculating, for each individual of the plurality of individuals, a predicted bid distribution based on the plurality of historical bids and one or more targeting attributes of said each individual;
calculating, using the predicted bid distribution for each individual of the plurality of individuals, a reserve price for displaying second content to said each individual;
setting a floor price of an auction for displaying third content to an individual of the plurality of individuals to the reserve price associated with the individual;
wherein the method is performed using one or more computing devices.

2. The method of claim 1, wherein calculating the reserve price for said each individual comprises calculating the reserve price using a linear regression.

3. The method of claim 2, wherein an explanatory variable of the linear regression is the one or more targeting attributes of an associated individual, and wherein a response variable of the linear regression is a log bid for the associated individual.

4. The method of claim 1, wherein the first content is an advertisement.

5. The method of claim 1, wherein each individual of the plurality of individuals is a user of a website, and wherein the advertisement is displayed on the website.

6. The method of claim 1, wherein the plurality of individuals comprise at least one new individual without any historical bids targeting the new individual.

7. The method of claim 1, wherein the one or more targeting attributes are supplied by the associated individual.

8. The method of claim 1, further comprising:
modifying the floor price for an individual of the plurality of individuals based on auction efficiency, wherein auction efficiency is a measure of a joint benefit of a service provider and an advertiser.

9. A system comprising:
one or more processors;
one or more computer-readable media storing instructions which, when executed by the one or more processors, cause:
receiving a plurality of historical bids for displaying first content to a plurality of individuals, wherein each of the plurality of historical bids targeted a segment of the plurality of individuals based on one or more targeting attributes of the plurality of individuals;
calculating, for each individual of the plurality of individuals, a predicted bid distribution based on the plurality of historical bids and one or more targeting attributes of said each individual;
calculating, using the predicted bid distribution for each individual of the plurality of individuals, a reserve price for displaying second content to said each individual;
setting a floor price of an auction for displaying third content to an individual of the plurality of individuals to the reserve price associated with the individual.

10. The system of claim 9, wherein calculating the reserve price for said each individual comprises calculating the reserve price using a linear regression.

11. The system of claim 10, wherein an explanatory variable of the linear regression is the one or more targeting attributes of an associated individual, and wherein a response variable of the linear regression is a log bid for the associated individual.

12. The system of claim 9, wherein the first content is an advertisement.

13. The system of claim 9, wherein each individual of the plurality of individuals is a user of a website, and wherein the advertisement is displayed on the website.

14. The system of claim 9, wherein the plurality of individuals comprise at least one new individual without any historical bids targeting the new individual.

15. The system of claim 9, wherein the one or more targeting attributes are supplied by the associated individual.

16. The system of claim 9, the instructions further causing:
modifying the floor price for an individual of the plurality of individuals based on auction efficiency, wherein auction efficiency is a measure of a joint benefit of a service provider and an advertiser.

17. A method comprising:
receiving, by a service provider, a bid from an advertiser participating in an auction to display an advertisement;
calculating, by the service provider, a floor price for the auction based on auction efficiency, wherein the auction efficiency is a measure of a joint benefit of the service provider and the advertiser;
wherein the floor price does not maximize revenue for the service provider;
wherein the method is performed using one or more computing devices.

18. The method of claim 17, wherein the floor price based on the auction efficiency results in approximately three percent of available locations for content going unsold.

19. The method of claim 17, wherein the auction is a second price auction.

20. The method of claim 17, wherein a target auction efficiency amount is used as a boundary in an equation for maximizing revenue for the auction.
